(19) United States
(12) Patent Application Publication
(10) Pub. No.: US 2012/0140036 A1
(43) Pub. Date: Jun. 7, 2012

(54) STEREO IMAGE ENCODING DEVICE AND METHOD

(76) Inventor: Yuki Maruyama, Osaka (JP)

(21) Appl. No.: 13/386,723

(22) PCT Filed: Dec. 21, 2010
(86) PCT No.: PCT/JP2010/007398

§ 371 Date: Jan. 24, 2012

(30) Foreign Application Priority Data
Dec. 28, 2009 (JP) 2009-298926

(51) Int. Cl. H04N 13/00

(52) U.S. Cl. 348/43; 348/E13.062

(57) ABSTRACT

Provided is a stereo image coding apparatus (100) including: a motion vector estimating unit (102) that calculates disparity information (102g) on a disparity between two image signals (101iX and 101iY) captured at two positions; a quantization parameter determining unit (103) that determines a quantization parameter (104p) based on the calculated disparity information so that the disparity in a portion of the three-dimensional image has a larger code amount as the disparity in the portion is larger; and an image coding unit (104) that codes the determined quantization parameter by quantization to generate a coded stream (100o) of a three-dimensional image signal.

### TECHNICAL FIELD

The present invention relates to a stereo image coding apparatus and a stereo image coding method for compress-coding a stereo image and recording the compress-coded data on a recording medium, such as an optical disc, a magnetic disk, and a flash memory.

### BACKGROUND ART

Generally, when video is coded, an information amount is compressed by reducing the redundancy in a temporal direction and a spatial direction. In the inter predictive coding for reducing the temporal redundancy, an amount of a motion (hereinafter referred to as “motion vector”) is estimated with reference to a preceding or following picture per block, and prediction is performed based on the estimated motion vector, thus increasing the prediction precision and improving the coding efficiency. For example, a motion vector of input image data to be coded is estimated, and prediction residual between a prediction value of a position shifted by the motion vector and the input image data to be coded is coded, thus reducing the information amount necessary for coding.

Here, a picture to be referred to when the motion vector is estimated is called a reference picture. Furthermore, a picture is a term that represents one screen. Without any inter predictive coding, a picture on which only intra prediction coding is performed for reducing the spatial redundancy is called an I-picture. Furthermore, a picture on which the inter predictive coding is performed with reference to one reference picture is called a P-picture. Furthermore, a picture on which the inter predictive coding is performed with reference to a maximum of two reference pictures is called a B-picture.

The proposed herein is a method of coding the first image signal in the same method as coding a monaural image signal different from a stereo signal, and coding the second image signal by performing motion compensation (disparity compensation) using frames of the first image signal at a same time.

FIG. 7 illustrates a proposed coding structure for coding a stereo image.

Pictures I0, B2, B4, and P6 represent frames included in the first image signal. Furthermore, pictures S1, S3, S5, and S7 represent frames included in the second image signal. The picture I0 is a picture to be coded as an I-picture. Furthermore, the picture P6 is a picture to be coded as a P-picture. Furthermore, the pictures B2 and B4 are pictures to be coded as B-pictures. Each of the arrows in FIG. 7 indicates that a picture pointed by the head of the arrow (destination point) can be referred to when a picture at the start point of the arrow (starting point) is coded. Furthermore, each of the pictures S1, S3, S5, and S7 refers to a frame of the first image signal at the same time as the corresponding picture. The picture type in coding may be P-picture or B-picture.

FIG. 8 illustrates an example of the coding order in coding with the coding structure in FIG. 7 and reference pictures to be used when each input picture is coded.

When pictures are coded with the coding structure in FIG. 7, the picture I0, the picture S1, the picture P6, the picture S7, the picture B2, the picture S3, the picture B4, and the picture S5 are sequentially coded in this coding order. Each of the pictures S1, S3, S5, and S7 is coded immediately after the corresponding frame in the first image signal at the same time as the picture is coded.

The first image signal indicates video for the right eye, and the second image signal indicates video for the left eye. The correlation between the frame included in the first image signal and the frame included in the second image signal that are at the same time is higher than the correlation between these frames at different times. Thus, disparity compensation is performed with reference to two frames at the same time, thus effectively reducing the information amount.

When the picture S3 is coded, reference pictures Sx may be used. Here, the reference pictures Sx to be used may include the picture S3.

Such a conventional technique in which the picture (B2) of an image signal (first image signal) is referred to when the picture (S3) of the other image signal (second image signal) is coded is known.

Here, the first image signal including the picture (B2) to be referred to by the picture (S3) of the second image signal may be an image signal for the left eye, or conversely an image signal for the right eye.

### CITATION LIST

### Patent Literature

[PTL 1] Japanese Unexamined Patent Application Publication No. 07-240944

### SUMMARY OF INVENTION

### Technical Problem

Probably since a region closer to a person is visually important for human beings in the stereo image coding, the efficient coding is possible by increasing a code amount allocated to the region.

Here, methods of determining whether the region is closer to or distant from the person include calculating an absolute sum of the prediction residual between the first image signal and the second image signal for a region to be determined, and determining that the region is closer to the person when the absolute sum is larger than a threshold (PTL 1).

However, the absolute sum of the prediction residual is not always in proportion to the distance from the person to a region.

FIG. 9 illustrates captured images of a chair, as an example of the stereo imaging. Here, a left-eye image 9X is an image of a first image signal, and a right-eye image 9Y is an image of a second image signal.

FIG. 10 schematically illustrates the images in FIG. 9. See FIG. 10 as necessary.

Although a region A (9XA and 9YA: attention region) is the closest portion (attention region) to a person, the correlation between the first image signal and the second image signal in this region A is high, and the absolute sum of the prediction residual is not large. Furthermore, a region B (9XB and 9YB: non-attention region) is a portion more distant than a distance to the region A, with respect to the person. However, since positions of the background in the images, that is, the boundaries between two hatching regions are different, the correlation between the first image signal and the second image signal in the region B is low, and the absolute sum of the prediction residual is large. As such, there is a problem that a region closer to a person and a region distant from the person cannot be accurately estimated in the conventional method, and a larger code amount is not allocated to a region visually important for human beings, thus leading to the inefficient coding.

The present invention has been conceived in view of the problem, and has an object of providing a stereo image coding apparatus and a stereo image coding method for improving the image quality and the coding efficiency.

### Solution to Problem

In order to solve the problems, a stereo image coding apparatus includes: an obtaining unit configured to obtain two image signals captured at two different positions, the two image signals being a first image signal and a second image signal; a calculating unit configured to calculate disparity information on a disparity between the two image signals obtained by the obtaining unit; a determining unit configured to determine a coding condition based on the disparity information calculated by the calculating unit so that a portion of a three-dimensional image generated from the obtained two image signals has a larger code amount as a current disparity or a past disparity of the portion (a predetermined one of the disparities) is larger; and a generating unit configured to code the three-dimensional image generated from the obtained two image signals, under the coding condition determined by the determining unit to generate a three-dimensional image signal indicating the three-dimensional image.

In other words, portions of a three-dimensional image may include a first portion of a relatively large first disparity and a second portion of a relatively small second disparity.

When a disparity of one of the first and second portions to be coded is the first disparity, the first coding condition as a coding condition for coding the portion may be determined. When a disparity of the portion to be coded is the second disparity, the second coding condition may be determined.

Furthermore, the first coding condition may be a condition under which the code amount generated in the coding is relatively large, and the second coding condition may be a condition under which the code amount generated in the coding is relatively small.

For example, the stereo image coding apparatus is a stereo image coding apparatus that codes a first image signal and a second image signal that are image signals of two images captured at different positions to generate a coded stream for a stereo image signal, and includes: a disparity information calculating unit that calculates disparity information for identifying a disparity between a first frame (for example, picture S3) included in the first image signal and a second frame (picture B2) included in the second image signal and captured at a same time when the first frame is captured; a quantization parameter determining unit that determines a first quantization parameter as a quantization parameter for coding when the disparity information calculated by the disparity information calculating unit is disparity information for identifying a disparity at a first distance (Yes at S302), and determines a second quantization parameter larger than the first quantization parameter when the disparity information is disparity information for identifying a disparity at a second distance longer than the first distance (No at S302); and a coding unit that codes one of the first and second image signals using the quantization parameter determined by the quantization parameter determining unit.

Here, the “captured at a same time” refers to the fact that one capturing time is closer to the other capturing time to an extent that the disparity information for determining an appropriate quantization parameter is calculated. More specifically, the “captured at a same time” may refer to, for example, being captured strictly at the same time or being captured at a time preceding by or after a lapse of one or more frames.

Furthermore, when the disparity information calculating unit calculates the disparity information of the disparity at the first distance shorter than the second distance, the quantization parameter determining unit may determine the first quantization parameter smaller than the second quantization parameter determined when the disparity information for the second distance is calculated. Thus, as the disparity information calculating unit calculates disparity information for a shorter distance, the quantization parameter determining unit may determine the smaller quantization parameter.

The stereo image coding apparatus may include a part of or an entire of characteristics of a following stereo image coding apparatus A1.

Furthermore, in order to achieve the object, the stereo image coding apparatus A1 is a stereo image coding apparatus that codes a first image signal and a second image signal that are captured at different positions to generate a coded stream for a stereo image signal, and includes: a motion vector calculating unit that calculates a motion vector between a first frame included in the first image signal and a second frame included in the second image signal and captured at a same time when the first frame is captured; a quantization parameter determining unit that determines a quantization parameter for coding, according to the motion vector determined by the motion vector calculating unit; and an image coding unit that codes one of the first and second image signals using the quantization parameter determined by the quantization parameter determining unit.

Furthermore, the quantization parameter determining unit of the stereo image coding apparatus A1 according to the present invention is additionally characterized by reducing the quantization parameter when the amount of disparity characteristics obtained from a horizontal component of the motion vector and indicating whether or not a region is close to a person is equal to or larger than a first threshold. Such an apparatus is a stereo image coding apparatus A2.

Furthermore, the quantization parameter determining unit of an the stereo image coding apparatus A1 according to the present invention is additionally characterized by increasing the quantization parameter when the amount of disparity characteristics is equal to or smaller than a second threshold. Such an apparatus is a stereo image coding apparatus A3.

Furthermore, an image coding unit in a stereo image coding apparatus A4 that is one of the stereo image coding apparatuses A1 to A3 according to the present invention is characterized by coding an image in accordance with the H.264.

Furthermore, a stereo image coding method A5 according to the present invention is a stereo image coding method of coding a first image signal and a second image signal that are captured at different positions to generate a coded stream for a stereo image signal, and includes: calculating a motion vector between a first frame included in the first image signal and a second frame included in the second image signal and captured at a same time when the first frame is captured; determining a quantization parameter for coding, according to the motion vector determined in the calculating; and coding one of the first and second image signals using the quantization parameter determined in the determining.

Furthermore, the stereo image coding method A5 according to the present invention is additionally characterized by reducing the quantization parameter when the amount of disparity characteristics obtained from a horizontal component of the motion vector and indicating whether or not a region is close to a person is equal to or larger than a first threshold. Such a method is a stereo image coding method A6.

Furthermore, the stereo image coding method A5 according to the present invention is additionally characterized by increasing the quantization parameter when the amount of disparity characteristics is equal to or smaller than a second threshold. Such a method is a stereo image coding method A7.

Furthermore, a stereo image coding integrated circuit A8 according to the present invention is a stereo image coding integrated circuit that codes a first image signal and a second image signal that are captured at different positions to generate a coded stream for a stereo image signal, and includes: a motion vector calculating unit that calculates a motion vector between a first frame included in the first image signal and a second frame included in the second image signal and captured at a same time when the first frame is captured; a quantization parameter determining unit that determines a quantization parameter for coding, according to the motion vector determined by the motion vector calculating unit; and an image coding unit that codes one of the first and second image signals using the quantization parameter determined by the quantization parameter determining unit.

Furthermore, a stereo image coding program A9 according to the present invention is a stereo image coding program for coding a first image signal and a second image signal that are captured at different positions to generate a coded stream for a stereo image signal, and includes: calculating a motion vector between a first frame included in the first image signal and a second frame included in the second image signal and captured at a same time when the first frame is captured; determining a quantization parameter for coding, according to the motion vector determined in the calculating; and coding one of the first and second image signals using the quantization parameter determined in the determining.

### Advantageous Effects of Invention

According to the present invention, a quantization parameter for coding is determined according to a motion vector between a first frame included in the first image signal and a second frame included in the second image signal and captured at a same time when the first frame is captured. Thus, a code amount can be allocated according to a disparity, and the image quality and the coding efficiency of the coded image can be improved.

### BRIEF DESCRIPTION OF DRAWINGS

FIG. 1 is a block diagram illustrating a configuration of a stereo image coding apparatus according to an embodiment.

FIG. 2 is a block diagram illustrating a detailed configuration of an image coding unit of the stereo image coding apparatus according to the embodiment.

FIG. 3 is a flowchart indicating an example of operations performed by a quantization parameter determining unit of the stereo image coding apparatus according to the embodiment.

FIG. 4 illustrates a space in which images of an object are captured, and the image coding apparatus.

FIG. 5 illustrates a relationship between disparity information and a quantization step width.

FIG. 6 illustrates a video camera.

FIG. 7 illustrates an example of a coding structure for coding stereo images.

FIG. 8 illustrates a coding order in coding stereo images in

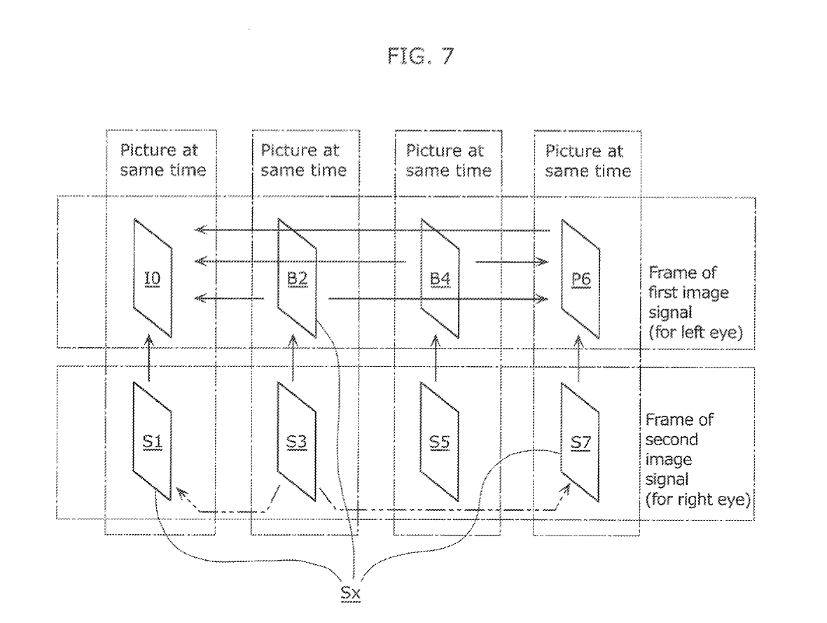

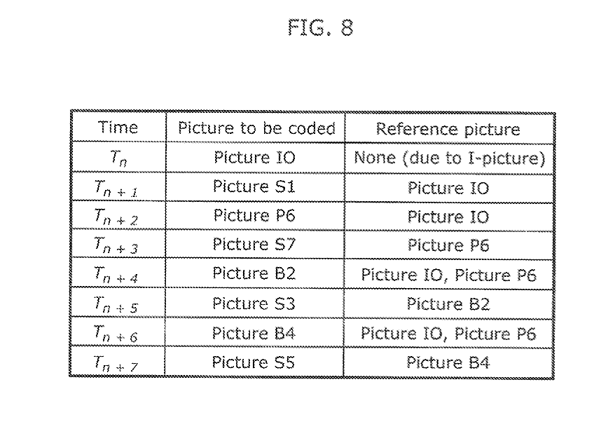

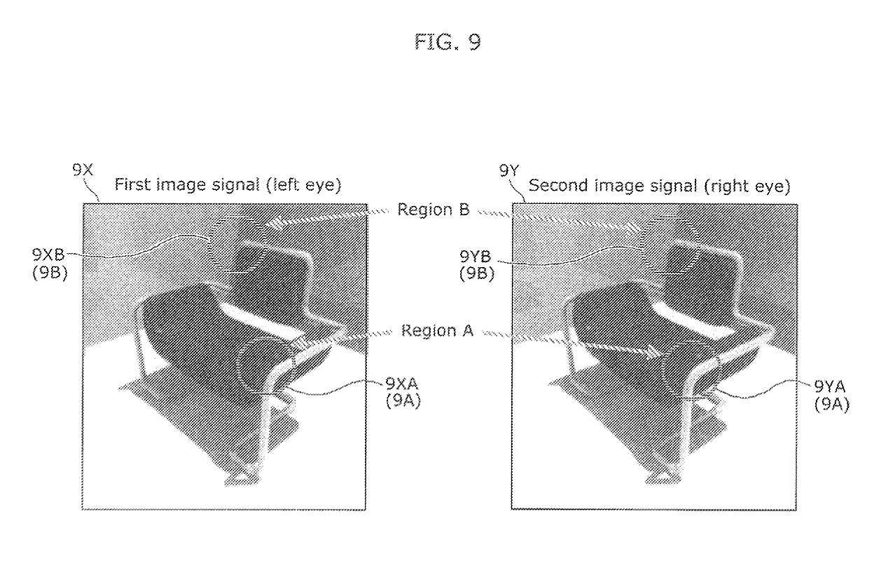

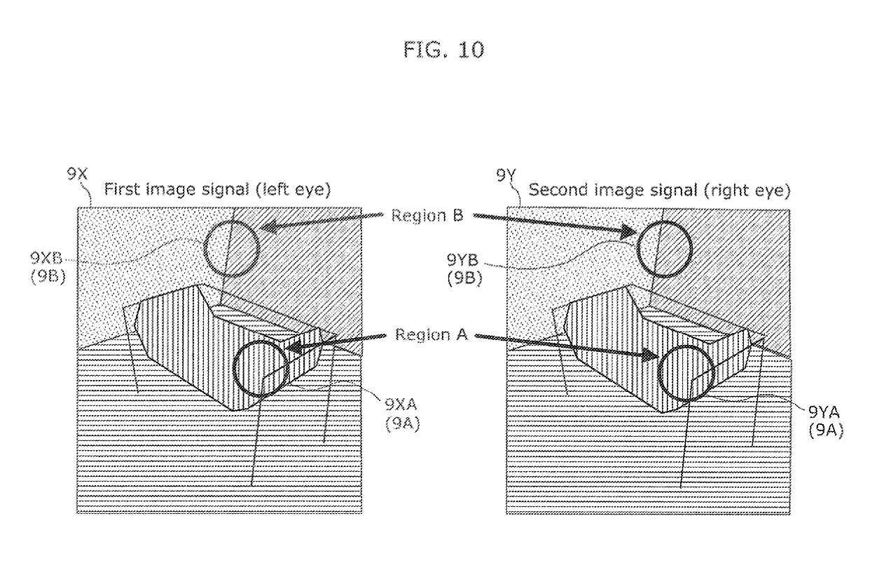

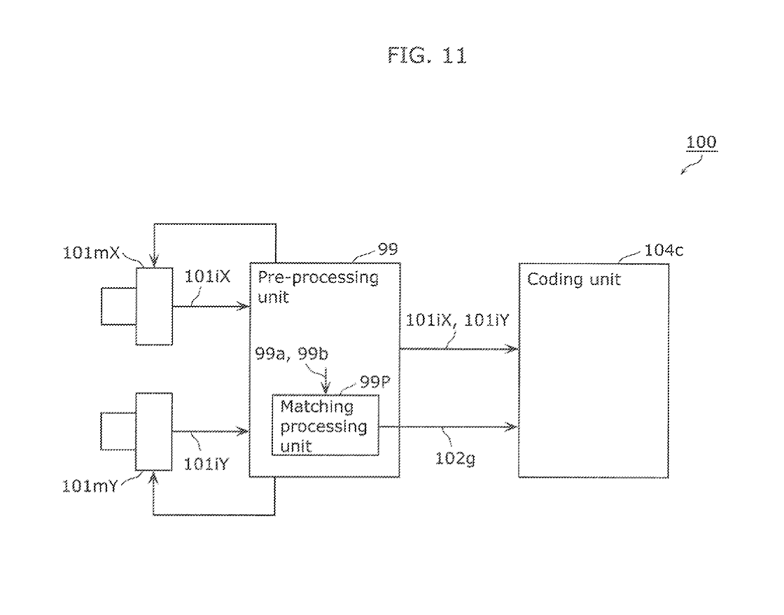

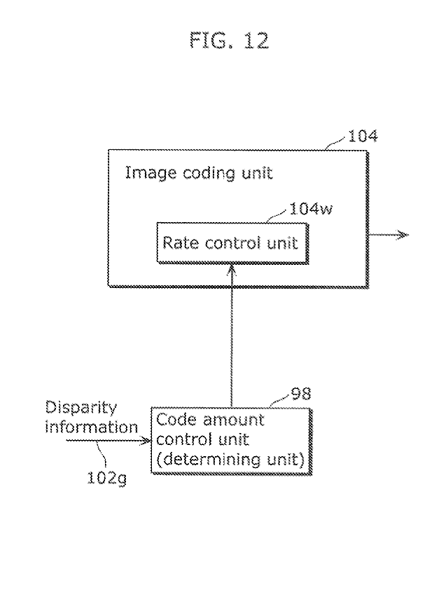

FIG. 7 and a relationship between input pictures and reference pictures.

FIG. 9 illustrates an example of stereo images.

FIG. 10 schematically illustrates stereo images.

FIG. 11 illustrates a pre-processing unit and others.

FIG. 12 illustrates a rate control unit and others.

### DESCRIPTION OF EMBODIMENTS

An embodiment of the present invention will be described with reference to drawings.

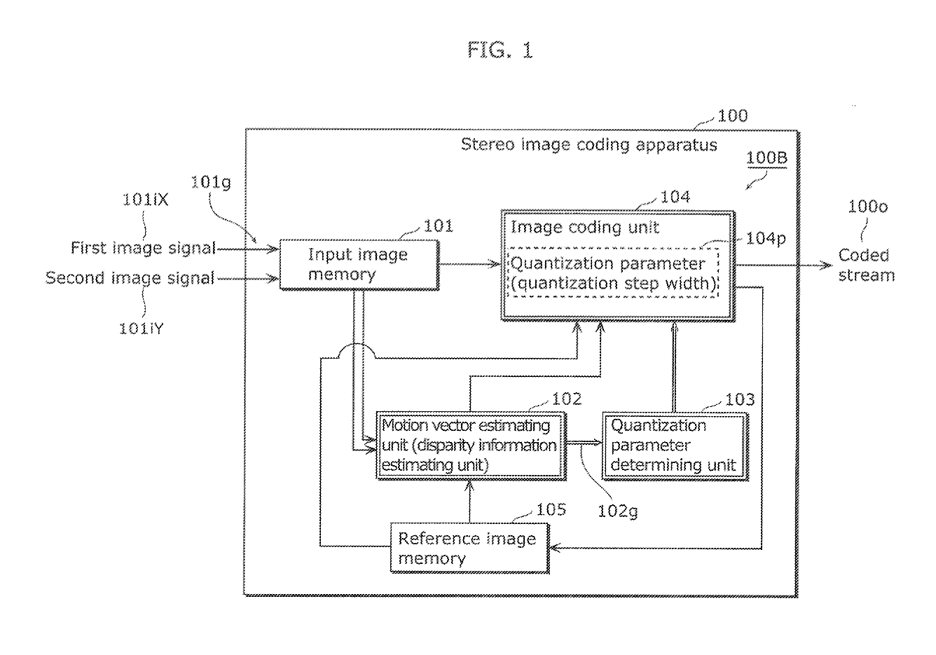

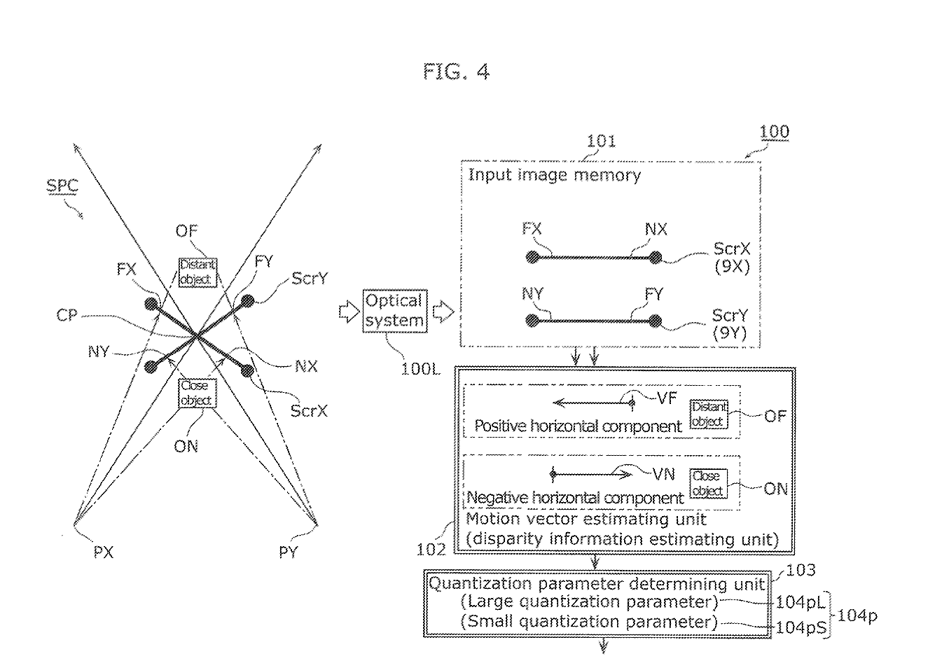

A stereo image coding apparatus 100 according to the present invention includes: an obtaining unit configured to obtain two image signals 101iX and 101iY captured at two different positions, the two image signals being a first image signal and a second image signal; a motion vector estimating unit 102 configured to calculate disparity information (motion vectors VF and VN in FIG. 4) on a disparity between the two image signals obtained by the obtaining unit; a quantization parameter determining unit 103 configured to determine a coding condition (quantization parameter 104p in FIG. 1) based on the disparity information calculated by the calculating unit so that a portion (region 9A, etc. in FIG. 9) of a three-dimensional image generated from the obtained two image signals has a larger code amount as a current (time at pictures B2 and S3 in FIG. 7) disparity or a past (time at pictures I0 and S1) disparity of the portion (a predetermined one of the disparities) is larger; and a coding unit 104 configured to code the three-dimensional image generated from the obtained two image signals, under the coding condition determined by the determining unit to generate a three-dimensional image signal (coded stream 100o) indicating the three-dimensional image.

More specifically, the stereo image coding apparatus 100 may be, for example, a stereo image coding apparatus that codes the first image signal (101iX) and the second image signal (101iY) that are two image signals of two videos captured at different positions (image-capturing positions PX and PY in FIG. 4) to generate a coded stream (100o) for a stereo image signal, and includes: a disparity information calculating unit (motion vector estimating unit 102) that calculates disparity information (motion vector, a horizontal component of the motion vector) for identifying a disparity (see description for FIG. 4, for example, a horizontal component of an angular difference between line-of-sight directions) between the first frame (image 9X, picture B2) included in the first image signal and the second frame (image 9Y, picture S3) included in the second image signal and captured at a same time as the first frame; a quantization parameter determining unit (103) that determines a first quantization parameter (104pS) as a quantization parameter for coding when the disparity information calculated by the disparity information calculating unit is disparity information (motion vector VN) for identifying a disparity at a first distance (Yes at S302) and determines a second quantization parameter (104pL) larger than the first quantization parameter when the disparity information is disparity information (motion vector VF) for identifying a disparity at a second distance longer than the first distance (No at S302); and a coding unit 104 that codes one of the first and second image signals (quantization of a (second) region of the second image signal 101iY (image 9Y)) using the quantization parameter determined by the quantization parameter determining unit.

More specifically, the disparity information identifies a disparity (angular difference between line-of-sight directions) between the second region included in the second frame (image 9Y, picture S3) and the first region (i) included in the first frame (image 9X, picture B2) and (ii) having a captured image of an object (object OF or ON in FIG. 4) that is also included in the second region. Furthermore, the image coding unit quantizes at least one of the first and second regions (here, second region) with the first quantization step width when the quantization parameter determining unit determines the first quantization parameter (Yes at S302), and quantizes one of the first and second regions with the second quantization step width larger than the first quantization step width when the quantization parameter determining unit determines the second quantization parameter (No at S302).

The following describes the details.

FIG. 1 is a block diagram illustrating a configuration of the stereo image coding apparatus 100 according to the embodiment.

The stereo image coding apparatus 100 according to the embodiment receives a first image signal 101iX and a second image signal 101iY, and outputs data obtained by coding the first image signal 101iX and the second image signal 101iY in the H.264 compression method, as a stream (coded stream 1000). In the coding of the H.264 compression method, one picture is divided into one or more slices, and the one or more slices are set to a processing unit. In the coding of the H.264 compression method according to the embodiment, one picture is assumed to be one slice, as an example.

In FIG. 1, the stereo image coding apparatus 100 includes an input image memory 101, a motion vector estimating unit 102, a quantization parameter determining unit 103, an image coding unit 104, and a reference image memory 105.

The input image memory 101 stores the first image signal 101iX and the second image signal 101iY received by the stereo image coding apparatus 100, as input image data to the stereo image coding apparatus 100. The information held by the input image memory 101 is referred to by the motion vector estimating unit 102 and the image coding unit 104.

The motion vector estimating unit 102 searches for a locally-decoded image stored in the reference image memory 105, estimates an image region that is the most similar to the input image data to be coded, determines a motion vector indicating the position of the image region, and transmits the information to the quantization parameter determining unit 103 and the image coding unit 104.

The quantization parameter determining unit 103 determines a quantization parameter to be used for coding, using the motion vector output from the motion vector estimating unit 102, and transmits the information to the image coding unit 104. The detailed operations of the quantization parameter determining unit 103 will be described later.

The image coding unit 104 compress-codes the input image data to be coded in the H.264 compression method, in accordance with the motion vector output from the motion vector estimating unit 102 and the quantization parameter output from the quantization parameter determining unit 103.

The reference image memory 105 stores the locally-decoded image output from the image coding unit 104. The information held by the reference image memory 105 is referred to by the motion vector estimating unit 102 and the image coding unit 104.

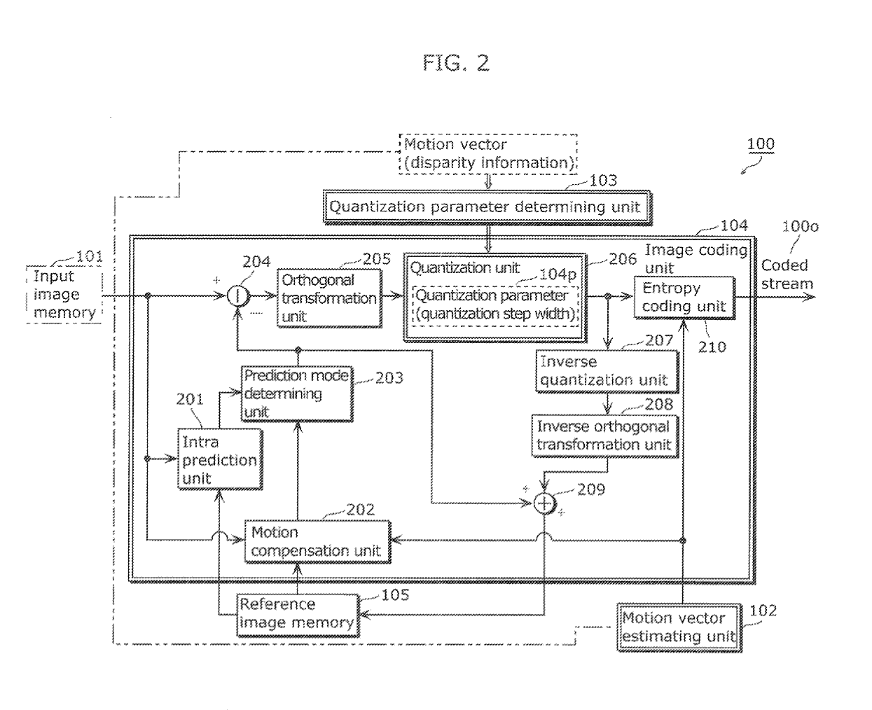

Next, a detailed configuration of the image coding unit 104 will be described with reference to FIG. 2.

FIG. 2 is a block diagram illustrating the detailed configuration of the image coding unit 104 in the stereo image coding apparatus 100 according to the embodiment.

In FIG. 2, the image coding unit 104 includes an intra prediction icy unit 201, a motion compensation unit 202, a prediction mode determining unit 203, a difference calculating unit 204, an orthogonal transformation unit 205, a quantization unit 206, an inverse quantization unit 207, an inverse orthogonal transformation unit 208, an adding unit 209, and an entropy coding unit 210.

The intra prediction unit 201 performs intra prediction using a coded pixel in the same image, based on the locally-decoded image stored in the reference image memory 105 to generate a predicted image of the intra prediction. Then, the intra prediction unit 201 outputs the generated predicted image to the prediction mode determining unit 203.

The motion compensation unit 202 extracts the optimal image region for the predicted image from the locally-decoded image stored in the reference image memory 105, using the motion vector included in the information received from the motion vector estimating unit 102, generates the predicted image of the inter prediction, and outputs the generated predicted image to the prediction mode determining unit 203.

The prediction mode determining unit 203 determines a prediction mode, switches between the predicted image generated in the intra prediction by the intra prediction unit 201 and the predicted image generated in the inter prediction by the motion compensation unit 202, based on a result of the determination, and outputs one of the predicted images. In other words, the prediction mode determining unit 203 selects one of the two predicted images, and outputs the selected predicted image. The prediction mode determining unit 203 may determine a prediction mode, for example, by calculating a sum of absolute differences between pixels of the input image data to be coded and pixels of the predicted image, for each of the inter prediction and the intra prediction, and determine one of the inter prediction and the intra prediction for which the calculated sum is smaller, as a prediction mode.

The difference calculating unit 204 obtains the input image data to be coded, from the input image memory 101. Then, the difference calculating unit 204 calculates a pixel difference value that is a value indicating a difference between the pixels of the obtained input image and the pixels of the predicted image output from the prediction mode determining unit 203, and outputs the calculated value to the orthogonal transformation unit 205.

The orthogonal transformation unit 205 transforms the pixel difference value received from the difference calculating unit 204 into a frequency coefficient, and outputs the transformed frequency coefficient to the quantization unit 206.

The quantization unit 206 quantizes the frequency coefficient received from the orthogonal transformation unit 205. Then, the quantization unit 206 outputs data obtained by quantizing the frequency coefficient, as the quantized data to the entropy coding unit 210 and the inverse quantization unit 207.

The inverse quantization unit 207 inversely quantizes the quantized data received from the quantization unit 206, reconstructs the resulting data into the frequency coefficient, and outputs the reconstructed frequency coefficient to the inverse orthogonal transformation unit 208.

The inverse orthogonal transformation unit 208 performs inverse frequency transformation on the frequency coefficient received from the inverse quantization unit 207 into the pixel difference value, and outputs the obtained pixel difference value to the adding unit 209.

The adding unit 209 adds the pixel difference value received from the inverse orthogonal transformation unit 208, to the predicted image output from the prediction mode determining unit 203, and outputs the resulting image as the locally decoded image to the reference image memory 105.

Here, the locally decoded image to be stored in the reference image memory 105 is substantially the same as the input image data stored in the input image memory 101. Here, the locally decoded image is an image obtained through (i) the orthogonal transformation by the orthogonal transformation unit 205, (ii) the quantization by the quantization unit 206, (iii) the inverse quantization by the inverse quantization unit 207, and (iv) the inverse orthogonal transformation by the inverse orthogonal transformation unit 208. Thus, the locally decoded image to be stored in the reference image memory 105 contains artifacts such as the quantization artifacts. Thus, the appropriate processing in view of the artifacts is performed using the reference image memory 105.

The entropy coding unit 210 entropy-codes the quantized data received from the quantization unit 206 and the motion vector and others received from the motion vector estimating unit 102, and outputs the coded data as the coded stream 100o.

In other words, the image coding unit 104 includes the quantization unit 206 that quantizes data that represents an image to be coded (frequency coefficient) into the quantized data. When quantizing data with a relatively small quantization step width, the quantization unit 206 quantizes the data into the quantized data with a larger data amount. In contrast, when quantizing data with a relatively large quantization step width, the quantization unit 206 quantizes the data into the quantized data with a smaller data amount.

Next, the operations performed by the stereo image coding apparatus 100 with such a configuration will be described.

The first image signal 101iX and the second image signal 101iY are stored in the input image memory 101. For example, the first image signal 101iX represents an image signal for the left eye, and the second image signal 101iY represents an image signal for the right eye. Then, each of the image signals includes, for example, 1920 pixels by 1080 pixels as the number of pixels. Conversely, the first image signal 101iX may be an image signal for the right eye, and the second image signal 101iY may be an image signal for the left eye. In this Description, the first image signal and the second image signal in FIG. 7 are referred to for the description of the first image signal 101iX and the second image signal 101iY, respectively.

The motion vector estimating unit 102 searches for a locally decoded image stored in the reference image memory 105, and estimates an image region the most similar to the input image data to be coded. In other words, the motion vector estimating unit 102 estimates the image region determined to have the content the most similar to that of the input image data, and determines a motion vector indicating the position of the image region.

The motion vector is estimated for each block. More specifically, the block (block to be coded) in the input image data (picture S3 in FIG. 7) to be coded is fixed for the estimation. The block (reference block) in the reference picture (picture B2) is moved within a search range. Then, a motion vector is estimated by locating a position of the reference block that is the most similar to the block to be coded. The processing for searching for the motion vector is called estimation of the motion vector. A relative error between the block to be coded and the reference block is generally used for determining whether or not the reference block is similar to the block to be coded. In particular, the method based on the sum of absolute difference (SAD) is well known. Since the computation amount increases when an entire reference picture is searched for the reference block, in generally, the search range is limited within the reference picture, and the limited range is called a search range.

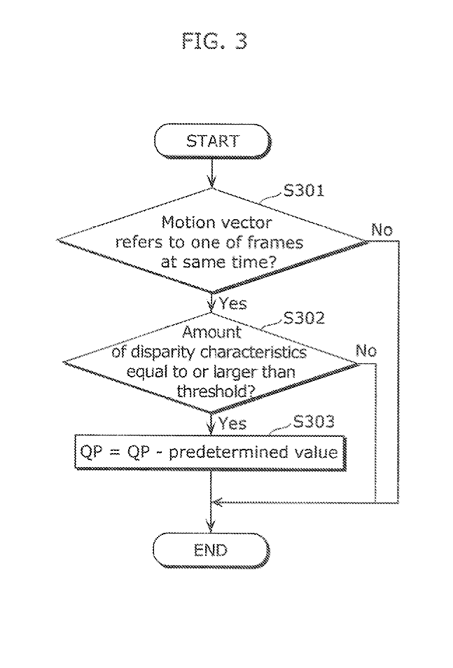

Next, an example of operations performed by the quantization parameter determining unit 103 will be described with reference to FIG. 3.

FIG. 3 is a flowchart indicating the example of operations performed by the quantization parameter determining unit 103 in the stereo image coding apparatus 100 according to the embodiment.

In FIG. 3, the quantization parameter determining unit 103 determines whether or not a motion vector output from the motion vector estimating unit 102 refers to one of frames at the same time (S301). Here, one of the frames at the same time is a frame (picture B2) of an image signal (first image signal) different from an image signal (second image signal) of the frame and located at the same time as the frame (picture S3 in FIG. 7) including the beginning of the motion vector. More specifically, the quantization parameter determining unit 103 determines, for example, whether or not the reference pictures Sx include the picture B2.

When determining that the motion vector does not refer to one of the frames at the same time (No at Step S301), the quantization parameter determining unit 103 outputs a preset value to the image coding unit 104 as a quantization parameter.

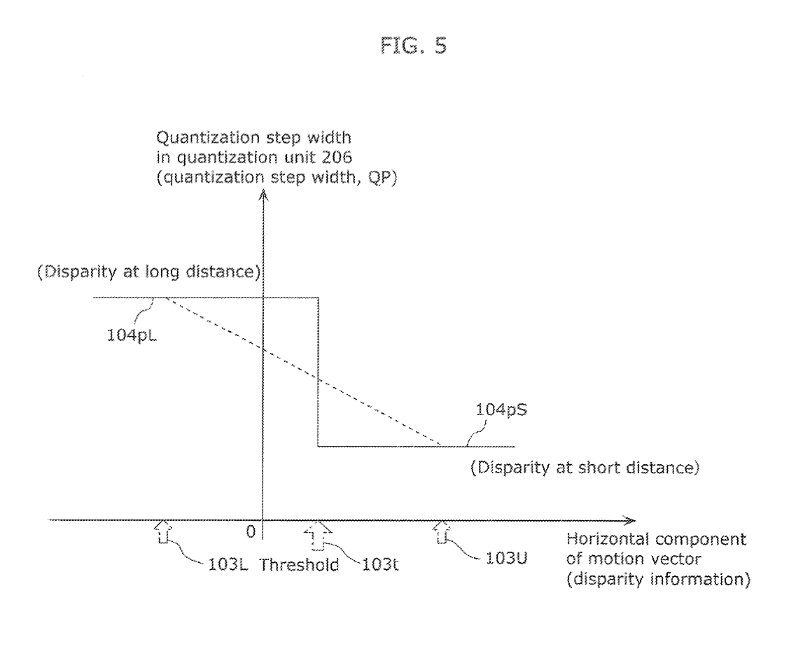

When determining that the motion vector refers to one of the frames at the same time (Yes at Step S301), the quantization parameter determining unit 103 determines whether or not an amount of disparity characteristics is equal to or larger than a predetermined threshold (threshold 103t in FIG. 5 to be described later) (S302). The amount of disparity characteristics is an amount (i) calculated using a horizontal component of the motion vector and (ii) indicating whether a region is closer to a person. The amount of disparity characteristics will be described in detail later.

As described above, it is determined at Step S301 whether or not the amount of disparity characteristics is equal to or larger than a predetermined threshold. With this determination, it may be understood that the quantization parameter determining unit 103 determines whether or not the motion vector with which the amount of disparity characteristics is calculated is a motion vector with which the amount of disparity characteristics equal to or larger than the threshold is calculated (motion vector VN or VF in FIG. 4). The description of FIGS. 4 and 5 will be described in detail later.

When determining that the amount of disparity characteristics is not larger than the predetermined threshold at S302 (No at S302), the quantization parameter determining unit 103 outputs a preset value (large quantization parameter 104pL in FIGS. 4 and 5) to the image coding unit 104 as a quantization parameter.

On the other hand, when determining that the amount of disparity characteristics is equal to or larger than the predetermined threshold at S302 (Yes at S302), the quantization parameter determining unit 103 outputs a value (small quantization parameter 104pS in FIGS. 4 and 5) obtained by subtracting a predetermined value from the preset value, to the image coding unit 104 as a quantization parameter.

Here, the amount of disparity characteristics is a parameter for example (i) indicating a region (9A in FIG. 9 (region A: attention region)) calculated using a horizontal component of the motion vector and (ii) indicating whether the region is closer to a person. The region closer to the person has a positive amount of disparity characteristics, and the region distant from the person (region 9B (region B: non-attention region)) has a negative amount of disparity characteristics. The first image signal 101iX and the second image signal 101iY are described with reference to FIG. 9 (FIG. 10) as necessary.

In the embodiment, the first image signal 101iX (image 9X) represents the image signal for the left eye, and the second image signal 101iY (image 9Y) represents the image signal for the right eye. Then, the picture of the first image signal 101iX is determined to be a reference picture of the picture of the second image signal 101iY (picture B2 in FIG. 7). Accordingly, the horizontal component of the motion vector of the region closer to the person (region 9A in FIG. 9 (attention region)) has a positive amount of disparity characteristics, and the region distant from the person (region 9B (non-attention region)) has a negative amount of disparity characteristics (see the following description for FIG. 5). Thus, the horizontal component of the motion vector is used as the amount of disparity characteristics.

The following two cases are opposite from the case where the horizontal component of the motion vector is used as the amount of disparity characteristics: a case where the first image signal 1011×(image 9X) represents the image signal for the right eye, and the second image signal 101iY (image 9Y) represents the image signal for the left eye; and a case where the first image signal 101iX is a reference picture for the second image signal 101iY. In other words, the horizontal component of the motion vector of the region closer to the person has a negative value, and the horizontal component of the motion vector of the region distant from the person has a positive value. Thus, the value indicating the horizontal component of the motion vector with the inverted sign is used as an amount of disparity characteristics.

The image coding unit 104 perform a series of coding processes, such as the intra prediction, motion compensation, orthogonal transformation, quantization, and entropy-coding, in accordance with the motion vector output from the motion vector estimating unit 102 and the quantization parameter output from the quantization parameter determining unit 103. Here, the image coding unit 104 according to the embodiment codes the input image data in accordance with the H.264 coding method.

The second frame included in one of image signals (the second image signal 101iY) to be coded with reference to the first frame of the other image signal (the first image signal 101iX) may be a start frame (picture S1). In other words, the second frame may be the start frame (picture S1), but not the frames subsequent to the picture S1 (picture S3 . . . ). The start frame (picture S1) is often coded prior to the subsequent frames (picture S3 . . . ). Thus, when a start frame is coded, the frames (picture S3 . . . ) of the image signal (second image signal 101iY) including the start frame is not referred to. In other words, the coding with reference to the frame (picture I0) of the other image signal (first image signal 101iX) is frequently performed. Thus, in many cases, the motion vector is available as disparity information. Accordingly, a complicated structure for obtaining disparity information other than the motion vector is not necessary.

As described above, the quantization parameter determining unit 103 of the stereo image coding apparatus 100 according to the embodiment determines a quantization parameter according to a value of a motion vector output from the motion vector estimating unit 102 when the motion vector refers to one of the frames at the same time (Yes at S301). Then, the image coding unit 104 compress-codes the input image data based on the determined quantization parameter. In other words, with such a configuration, a region closer to a person, that is, a region (9A) visually important for human beings is coded by preferentially assigning a larger amount of codes. Thus, the coding efficiency can be increased. Thus, the image quality and the coding efficiency can be improved.

In other words, when an important region is quantized, disparity information on a disparity for a short distance is calculated, and the disparity information is quantized with a small quantization step width identified by a small first quantization parameter (Yes at S301), thus resulting in the higher image quality. On the other hand, when an unimportant region is quantized, disparity information on a disparity for a long distance is calculated, and the disparity information is quantized with a large quantization step width (No at S301), thus resulting in the higher coding efficiency. Accordingly, the higher image quality and the higher coding efficiency are compatible.

Next, an example of the details of the stereo image coding apparatus 100 will be described with reference to FIGS. 4 and 5. The following description is only an example, and a part or an entire of the image coding apparatus 100 may differ from the following description.

FIG. 4 illustrates a space SPC in which images are captured, and the image coding apparatus 100.

An image-capturing position PX is a position at which an image (9X) for the left eye indicated by the first image signal 101iX is captured.

An image-capturing position PY is a position at which an image (9Y) for the right eye indicated by the second image signal 101iY is captured. The image 9Y for the right eye is viewed by the right eye, and the image 9X for the left eye is viewed by the left eye. Accordingly, the user perceives (views) a three-dimensional (3D) image. The image-capturing position PY is horizontal to the image-capturing position PX. Furthermore, the image-capturing position PY is to the right of the image-capturing position PX with respect to the image-capturing direction that is an upward direction in FIG. 4.

Here, the image 9X is an image captured at the same time when the image 9Y is captured.

A screen ScrX is a virtual screen on which the image 9X is displayed and is for understanding the image 9X captured at the image-capturing position PX. As described above, the screen ScrX is a screen for the image-capturing position PX to the left. Thus, a captured image of an object ON (object (subject) of the region 9B) in relatively close from the image-capturing positions PX and PY is displayed in a right portion NX on the screen ScrX. In addition, a captured image of an object OF (object (subject) of the region 9A) relatively distant from the image-capturing positions PX and PY is displayed in a left portion FX on the screen ScrX.

A screen ScrY is a virtual screen corresponding to the image-capturing position PY. Contrary to the other screen ScrX, a captured image of the close object ON is displayed in a left portion NY on the screen ScrY. Furthermore, a captured image of the distant object OF is displayed in a right portion FY on the screen ScrY.

As described above, each captured image of the close object ON is displayed in the right portion NX on the screen ScrX, and in the left portion NY on the screen ScrY. Thus, the horizontal component of the motion vector VN from the portion NY to the portion NX is a horizontal component with the motion from the left to the right, that is, a horizontal component having a relatively larger value.

On the other hand, each captured image of the distant object OF is displayed in the left portion FX on the screen ScrX, and in the right portion FY on the screen ScrY. Thus, the horizontal component of the motion vector VF from the portion FY to the portion FX is a horizontal component with the motion from the right to the left, that is, a horizontal component having a relatively smaller value.

Here, a crosspoint CP is a position at which an image-capturing direction of the image-capturing position PX crosses an image-capturing direction of the image-capturing position PY, and is the center of each of the screens ScrX and ScrY in the horizontal direction.

Furthermore, the close object ON is, for example, an object at a distance shorter than the crosspoint CP. Thus, the captured image of the close object ON is displayed at the right portion NX to the right of the center of the screen ScrX, and at the left portion NY to the left of the center of the screen ScrY. Thus, the horizontal component of the motion vector VN from the portion NY to the portion NX has a positive value.

On the other hand, the distant object OF is, for example, an object at a distance longer than the crosspoint CP. Thus, the horizontal component of the motion vector VF for the distant object OF has a negative value.

The close object ON may, for example, have a pop-up amount corresponding to a (positive) absolute value of the horizontal component of the motion vector VN for the object ON with respect to the position of the screen on which the 3D images are displayed. The 3D images include the images 9Y and 9X. Similarly, the distant object OF may, for example, have a pulling-in amount corresponding to a (negative) absolute value of the horizontal component of the motion vector VF for the object OF with respect to the position of the screen on which the 3D images are displayed.

The stereo image coding apparatus 100 receives the image 9X for which the motion vector VN is calculated and the image 9Y for which the motion vector VF is calculated.

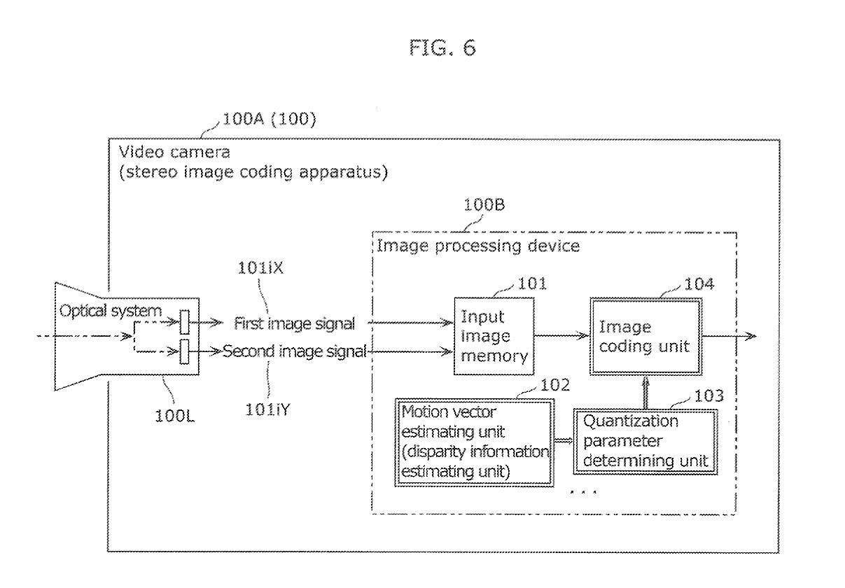

For example, the stereo image coding apparatus 100 may include an optical system 100L (FIG. 6) that obtains light in the space SPC including the image-capturing positions PX and PY. The stereo image coding apparatus 100 receives, for example, the images 9X and 9Y by obtaining the light from the optical system 100L.

The image coding unit 104 codes a region in the image 9Y to be referred to (second region: portion NY or FY), out of the images 9X and 9Y as follows. More specifically, the coding is performed with reference to a region (first region: portion NX or FX) with a captured image of an object (object ON or OF) included in the second region, in the image 9X to be referred to.

As described above, the image coding unit 104 may code the first region with reference to the second region for the right eye.

The image coding unit 104 quantizes data for a target region (second region) for which the quantization step width is controlled, out of the first and second regions, into the quantized data. Then, the image coding unit 104 generates the stream including the quantized data as the coded stream 100o.

The motion vector estimating unit 102 searches regions in the image 9X for the first region, and calculates the motion vector (motion vector VF, VN) from the searched first region to the second region.

Here, the calculated motion vector identifies a disparity between the first and second regions, that is, an angular difference between the line-of-sight directions for viewing the first and second regions, and identifies a distance to an object as a distance identified by the identified disparity.

In other words, (a horizontal component of) the calculated motion vector (VN) indicating a large value such as a positive value indicates that an object is close (close object ON, region 9A). On the other hand, the calculated motion vector (VF) indicating a small value such as a negative value indicates that an object is distant (distant object OF, region 9B).

In other words, (the horizontal component of) the calculated motion vector is disparity information (distance information, amount of disparity characteristics) indicating whether an object is close or distant.

The quantization parameter determining unit 103 identifies the relatively small quantization parameter 104pS (QP—(predetermined value) in FIG. 3, value obtained by subtracting the predetermined value) when the disparity information estimated by the motion vector estimating unit 102 is disparity information for the relatively short distance (motion vector VN) (Yes at S302). Furthermore, the quantization parameter determining unit 103 identifies the relatively large quantization parameter 104pL (value obtained by not subtracting the predetermined value) when the estimated disparity information is disparity information for the relatively long distance (motion vector VF) (No at S302).

In other words, the quantization parameter determining unit 103 identifies a small quantization step width identified with the relatively small quantization parameter 104pS, when the disparity information is disparity information for a short distance. Furthermore, the quantization parameter determining unit 103 identifies a large quantization step width identified with the relatively large quantization parameter 104pL, when the disparity information is disparity information for a long distance.

As such, quantization step width data for identifying a quantization step width is identified. The quantization step width data may be not only a quantization parameter (for example, QP in the H.264/AVC) but also, for example, a quantization matrix in the H.264/AVC to be described later.

Then, the quantization parameter determining unit 103 causes the image coding unit 104 to quantize the target region (second region) for which the quantization step width is controlled in the quantization, using the identified quantization step width. Accordingly, the quantization parameter determining unit 103 causes the image coding unit 104 to generate the coded stream 100o with the data amount corresponding to the disparity information (identified distance).

More specifically, the quantized data included in the coded stream 100o is data processed by the entropy coding unit 210 and others after the quantization.

FIG. 5 illustrates a relationship between disparity information and a quantization step width used for quantization by the quantization parameter determining unit 103.

For example, the relationship between disparity information and a quantization step width is represented by a solid line.

In the graph of FIG. 5, the horizontal axis represents a horizontal component (disparity information) of a motion vector estimated by the motion vector estimating unit 102. In addition, the vertical axis represents a quantization step width used for quantization by the quantization parameter determining unit 103.

When the disparity information is disparity information larger than a threshold 103t and on a disparity at a distance closer than a distance of the threshold 103t (Yes at S302, motion vector VN), the disparity information corresponds to a smaller quantization step width indicated by the small quantization parameter 104pS. On the other hand, when the disparity information is disparity information equal to or smaller than the threshold 103t and on a disparity at a distance longer than the distance of the threshold 103t (No at S302, motion vector VF), the disparity information corresponds to a larger quantization step width indicated by the large quantization parameter 104pL.

Here, the relationship between the disparity information and the quantization step width may be represented by, for example, a dashed line.

In a range from a lower limit 103L to an upper limit 103U, the quantization step width corresponding to the disparity information represented by the dashed line monotonically decreases, according the change in the disparity information to information at a closer distance (to the right). In other words, the quantization step width of the disparity information in this range is smaller than a quantization step width corresponding to the disparity information for a distance longer than the distance of the disparity information (to the left) of the quantization step width, and is larger than a quantization step width corresponding to the disparity information for a distance shorter than the distance of the disparity information (to the right). Accordingly, an appropriate quantization step width with higher precision is available because a quantization step width with a medium size is used.

Furthermore, in the data of the dashed line in a range to the right of the upper limit 103U (shorter distance), the quantization step width corresponding to the disparity information neither changes nor decreases even when the disparity information is changed to the right. Similarly, the quantization step width corresponding to the disparity information in the range to the left of the lower limit 103L (longer distance) does not increase even when the disparity information is changed to the left. Accordingly, the negative effect due to a too large or small quantization step width can be prevented. For example, an image quality of an object much farther than the distance from the distant object OF can be prevented from being degraded by a too small quantization step width.

As an example, the quantization step width of the disparity information with the upper limit 103U may be a quantization step width with the smaller quantization parameter 104pS. Furthermore, the quantization step width of the disparity information with the lower limit 103L may be a quantization step width with the larger quantization parameter 104pL.

As such, the stereo image coding apparatus 100 including the image coding unit 104, a disparity information calculating unit (motion vector estimating unit 102), and a quantization step width control unit (the quantization parameter determining unit 103) is constructed.

The image coding unit 104 quantizes data of one of a first region and a second region into quantized data. The first region is included in a first image (9X), the second region is included in a second image (9Y), and the first region and the second region have respective captured images of the same object (close object ON or distant object OF). Here, the first image and the second image are two images allowing a viewer to view 3D images (three-dimensional view), where the first image is viewed by one eye and the second image is viewed by the other eye.

The disparity information calculating unit calculates disparity information (motion vector, horizontal component of the motion vector). Here, the calculated disparity information identifies a disparity (horizontal component of an angular difference between line-of-sight directions) between the first region and the second region to identify a distance corresponding to the disparity as a distance to the object.

When the disparity information calculated by the disparity information calculating unit identifies a shorter first distance (Yes at S302), the quantization step width control unit causes the image coding unit to perform quantization with a smaller quantization step width. In other words, the data is quantized into data with a large amount. On the other hand, when the disparity information identifies a longer second distance (No at S302), the quantization step width control unit causes the image coding unit to perform quantization with a larger quantization step width. In other words, the data is quantized into data with a small amount.

Accordingly, a closer and important region (attention region) is quantized into data with the large amount (Yes at S302), so that the image quality can be increased. Furthermore, a more distant and unimportant region (non-attention region) is quantized into data with the small amount, so that the coding efficiency can be improved. Thus, the higher image quality and the higher coding efficiency are compatible.

The embodiment is described, but the present invention is not limited to this.

For example, in the embodiment, a method of changing a quantization parameter according to a motion vector for motion compensation is described. However, the present invention is not limited to this. For example, the stereo image coding apparatus according to the present invention may include a pre-processing unit that estimates a disparity between the first image signal and the second image signal before the signals are transmitted to an input image memory. The pre-processing unit is a disparity information estimating unit (second disparity information calculating unit) to be described later, which estimates another disparity information different from a motion vector. The quantization parameter may be changed according to a result of the estimation. The examples of this method includes a method of estimating a motion vector from an image obtained by reducing the first and second image signals to one sixteenth, and determining a disparity from the calculated motion vector. The motion vector indicating a disparity may be calculated using other methods.

The pre-processing unit will be described later in detail.

Furthermore, the embodiment describes, but not limited to, an example of the method of reducing a quantization parameter when the amount of disparity characteristics is determined to be equal to or larger than a predetermined threshold. In other words, when the amount of disparity characteristics is determined to be smaller than the predetermined threshold, the quantization parameter may be set smaller. Here, the region (9A, 9B, etc) from which the amount of the disparity characteristics is obtained indicates a region at a shorter distance as the amount of the disparity characteristics indicates a smaller value.

Furthermore, the embodiment describes, but not limited to, an example of the method of changing a quantization parameter when the amount of disparity characteristics is determined to be equal to or larger than a predetermined threshold. In other words, the quantization parameter may be changed, for example, in proportion to a value of the amount of disparity characteristics (dashed line in FIG. 5). Furthermore, the amount of change in the quantization parameter may have the upper limit and the lower limit.

Furthermore, the embodiment describes, but not limited to, an example of applying the H.264 standard as a compression coding scheme. In other words, the present invention may be applicable to other compression coding schemes.

As described above, the stereo image coding apparatus 100 determines a quantization parameter to be used for coding, according to a motion vector between the first frame (image 9Y) included in the first image signal and the second frame (image 9X) included in the second image signal. The second frame is captured at the same time when the first frame is captured. Since the appropriate quantization parameter is determined, the image quality and the coding efficiency of the coded image can be improved.

The present invention is not limited to the implementation of the stereo image coding apparatus 100 including each of the constituent elements according to the embodiment. In other words, the present invention may be implemented as a stereo image coding method using the processes performed by the constituent elements included in the stereo image coding apparatus as steps, a stereo image coding integrated circuit including the constituent elements, and a stereo image coding program for implementing the stereo image in coding method.

The stereo image coding program may be distributed by a recording medium, such as a Compact Disc-Read Only Memory (CD-ROM) and via a communication network, such as the Internet.

Furthermore, the stereo image coding integrated circuit may be implemented as an LSI that is a typical integrated circuit. In this case, the LSI may be in one chip or a plurality of chips. For example, the functional blocks other than a memory may be integrated into a single chip LSI. The name used here is LSI, but it may also be called IC, system LSI, super LSI, or ultra LSI depending on the degree of integration.

Moreover, ways to achieve integration are not limited to the LSI, and a special circuit or a general purpose processor and so forth can also achieve the integration. Field Programmable Gate Array (FPGA) that can be programmed after manufacturing LSI or a reconfigurable processor that allows re-configuration of the connection or configuration of an LSI can be used for the same purpose.

In the future, with advancement in semiconductor technology, a brand-new technology may replace LSI. The functional blocks can be integrated using such a technology. One such possibility is that the present invention is applied to biotechnology.

When the functional blocks are integrated, only a unit for storing data among the functional blocks may be separated and not integrated into one chip.

FIG. 6 illustrates a video camera 100A.

More specifically, the stereo image coding apparatus 100 may be the video camera 100A in FIG. 6. The stereo image coding apparatus 100 may be not the entire of the video camera 100A but a part of the video camera 100A, such as an image processing device 100B.

The stereo image coding apparatus 100 includes the optical system 100L (FIG. 4) and the image processing device 100B.

The image processing device 100B includes an arithmetic circuit and a storage device, and is an information processor that processes information.

The image processing device 100B includes a computer including a CPU, a ROM, and a RAM, and a part of or an entire of the information processing performed by the image processing device 100B may be executed by the computer.

The image processing device 100B includes the input image memory 101, the image coding unit 104, the motion vector estimating unit 102, and the quantization parameter determining unit 103, and that is, has functions of the input image memory 101 and others.

The optical system 100L is an optical system that obtains light for obtaining the images 9X and 9Y. More specifically, the optical system 100L separates light entered into one lens, into light for obtaining the image 9X for the left eye and light for obtaining the image 9Y for the right eye. Accordingly, the optical system 100L forms an image by combining two of the images 9X and 9Y. In other words, the optical system 100L may be, for example, a single-eyed optical system. The video camera 100A (stereo image coding apparatus 100) may be, for example, a single-eyed 3D video camera including the single-eyed optical system 100L.

Furthermore, in the stereo image coding apparatus (100), the first image signal (101iX) may be not an image signal for the left eye but an image signal for the right eye. Furthermore, the second image signal (101iY) may be not an image signal for the right eye but an image signal for the left eye.

Furthermore, the stereo image coding apparatus 100 may perform rate control. Furthermore, the large second quantization parameter (104pL) may be a quantization parameter identical to the quantization parameter selected with the rate control in order to achieve a target data amount. Furthermore, the small first quantization parameter (104pS) may be a quantization parameter obtained by subtracting a predetermined value (S303 in FIG. 3) from the quantization parameter selected with the rate control.

Furthermore, a control value in the rate control may be determined after the quantization parameter determining unit determines a quantization parameter. Here, the control value to be determined may be, for example, a value with which a target value can be achieved under the determined quantization parameter.

Furthermore, the quantization parameter determining unit of the stereo image coding apparatus may determine a common quantization parameter to be used for quantizing any of regions included in a macroblock. Furthermore, the image coding unit may quantize any of regions included in a macroblock with a quantization step width identified by the determined common quantization parameter.

Here, for example, the quantization parameter determining unit may determine the small first quantization parameter (104pS) only in the following case even when the disparity information between the first region and the second region is disparity information (motion vector VN) at a short distance. In other words, the quantization parameter determining unit may determine the small first quantization parameter (104pS) as the common quantization step width (Yes at S302) only when the disparity information of a region other than the second region is the disparity information in (motion vector VN) at a short distance. Furthermore, the quantization parameter determining unit may determine the large second quantization parameter (104pL) as the common quantization step width (No at S302) only when the disparity information of a region other than the second region is the disparity information (motion vector VF) at a long distance.

Here, the second region may be, for example, a sub-block or a search block.

Furthermore, the quantization parameter determining unit of the stereo image coding apparatus identifies a quantization step width by determining a quantization parameter for identifying the quantization step width as described above. In other words, the quantization parameter determining unit may be an example of a quantization step width identifying unit that identifies a quantization step width.

The stereo image coding apparatus may conform to a standard entirely or partially different from the H.264.

In other words, the quantization step width identifying unit may select, for example, a quantization matrix of a region (or a macroblock) for each region included in an image (9Y, etc.) or for each macroblock including the region. Accordingly, the quantization step width identifying unit identifies the quantization step width identified by the quantization matrix.

More specifically, the quantization step width identifying unit may identify a quantization matrix with which an appropriate quantization step width corresponding to the disparity information is identified. In other words, the quantization step width identifying unit may select an appropriate quantization step width corresponding to the identified quantization matrix.

More specifically, the quantization step width identifying unit may identify an appropriate quantization matrix from among quantization matrices.

As such, a quantization step width determining unit identifies quantization step width identifying data for identifying a quantization step width (at least one of a quantization parameter and a quantization matrix) to quantize the second region with the quantization step width identified by the identified quantization step width identifying data.

Furthermore, for example, the disparity information calculating unit of the stereo image coding apparatus may search the regions of the first frame (picture B2) for the first region having a captured image of an object (close object ON or distant object OF) included in the second region of the second frame (picture S3). Furthermore, the disparity information calculating unit may calculate a motion vector from the searched first region to the second region. Then, the image coding unit may code the second region (picture S3) with reference to the first region (picture B2) for which the disparity information calculating unit calculates the motion vector. Furthermore, the disparity information may be a horizontal component of the motion vector calculated by the disparity information calculating unit. The quantization parameter determining unit may determine the quantization parameter based on as the horizontal component of the motion vector. Then, the image coding unit may quantize the second region based on the quantization parameter determined by the quantization parameter determining unit, when the second region of the second frame (picture S3) is coded.

Accordingly, there is no need to separately prepare another data that is not a motion vector as disparity information because (a horizontal component of) the motion vector is used as the disparity information, and the higher image quality and the higher coding in efficiency are compatible with the simplified processing.

On the other hand, the disparity information may be another data different from the motion vector.

Furthermore, a region for which a quantization step width for quantization is controlled may be not the second region (region of the image 9Y (picture S3)) but may be the first region (region of the image 9X (picture B2)).

In other words, for example, the image coding unit of the stereo image coding apparatus may code the first frame (picture B2) prior to coding of the second frame (picture S3). Furthermore, the disparity information calculating unit (second disparity information calculating unit) may calculate the disparity information prior to coding of the first frame (picture B2). Then, the quantization parameter determining unit may determine the quantization parameter based on the disparity information calculated by the disparity information calculating unit prior to coding of the first frame (picture B2). Furthermore, the image coding unit may quantize the first region included in the first frame (picture B2) based on the determined quantization parameter.

More specifically, the first frame (picture B2) and the second frame (picture S3) may be stored in an input buffer (for example, the input image memory 101) before the image coding unit codes the first frame (picture B2). Furthermore, the disparity information calculating unit may calculate the disparity information using the first frame and the second frame stored in the input buffer, prior to coding of the first frame (picture B2).

Accordingly, the appropriate quantization parameter is available with the quantization of the first frame (image 9X, picture B2), and sufficiently high image quality and sufficiently high coding efficiency can be obtained.

As such, when the disparity information (the motion vector 102g in FIG. 1) is information on a disparity at a shorter distance, that is, disparity information (motion vector VN in FIG. 4) on the large disparity (region 9A in FIG. 9), the first coding condition (quantization parameter 104pS (FIG. 4), smaller quantization step width, and smaller QP value) may be determined.

Furthermore, when the disparity information is information on a disparity at a longer distance, that is, disparity information (motion vector VF) on the small disparity (region 96 in FIG. 9), the second coding condition (quantization parameter 104pL, larger quantization step width, and larger QP value) may be determined.

For example, the first coding condition (relatively small quantization step width and QP value, etc.) has a relatively large code amount when coding is performed under the coding condition.

For example, the first coding condition (relatively large quantization step width and QP value, etc.) has a relatively small code amount when coding is performed under the coding condition.

In other words, as the disparity of the disparity information is larger, the coding condition with which the code amount becomes larger may be determined, and control may be performed such that the code amount becomes larger.

The coding under the first coding condition may be coding in the first standard, and the coding under the second coding condition may be coding in the second standard.

In other words, each portion (regions 9A and 9B in FIG. 9) may be coded under an appropriate coding condition corresponding to the disparity information of the disparity in the portion.

Furthermore, the code amount of coded data may be larger when coding is performed under the first coding condition using the first quantization matrix.

Furthermore, the code amount may be smaller when coding is performed under the second coding condition using the second quantization matrix different from the first quantization matrix.

The operation according to the technique herein is, for example, an operation with the code amount identified by analyzing the operation using an analysis tool.

The coding according to the technique herein may be, for example, coding in accordance with the Multi-view Video Coding (MVC).

Furthermore, the technique herein may use the side-by-side format, for example.

In other words, the first picture (image 9X in FIG. 9) of the first image signal 101iX (FIG. 1) may be a picture corresponding to a first part included in an image, such as a left half in the image.

Furthermore, the second picture of the second image signal 101iY (image 9Y in FIG. 9) may be a second part included in an image, such as a right half in the image.

In other words, the first picture may be, for example, a picture corresponding to an image obtained by horizontally doubling the size of the image of the first part.

The second picture may be, for example, a picture corresponding to an image obtained by horizontally doubling the size of the image of the second part.

Similarly, the top-and-bottom format and other formats may be used.

Furthermore, the stereo image coding apparatus 100 may be a reproducing apparatus that reproduces the first and second image signals (first and second image signals 101iX and 101iY in FIG. 1) recorded onto a recording medium, such as a Digital Video Disc (DVD) recorder and a blu-ray recorder.

Furthermore, the stereo image coding apparatus 100 may, for example, correct a disparity between the first and second image signals to be reproduced.

In order to correct the disparity, the stereo image coding apparatus 100 may include a calculating unit that calculates the disparity information of the disparity to be corrected.

Furthermore, the DVD recorder and others (stereo image coding apparatus 100) may perform coding under the coding condition corresponding to the disparity information calculated by such a calculating unit.

The next operation may be performed, for example, only in a certain phase.

In other words, for example, an obtaining unit 101g in FIG. 1 may obtain the first and second image signals 101iX and 101iY (FIG. 1) that are two image signals captured at the two image-capturing positions PX and PY (FIG. 4) that are different from each other.

Furthermore, the motion vector estimating unit 102 may calculate the disparity information (disparity information 102g in FIG. 1) on the disparity between the obtained two image signals 101iX and 1011Y.

Furthermore, the quantization parameter determining unit 103 may determine a coding condition (quantization parameter 104p in FIG. 1) based on the disparity information calculated by the calculating unit so that a portion (region 9A in FIG. 9) of a three-dimensional image generated from the obtained two image signals 101iX and 101iY has a larger code amount as a current (for example, time at the pictures B2 and S3 in FIG. 7) disparity or a past (for, example, time at the pictures I0 and S1) disparity of the portion (a predetermined one of the disparities) is larger.

In other words, the quantization parameter determining unit 103 may determine a coding condition based on, for example, one disparity indicated by disparity information.

Furthermore, the image coding unit 104 may generate a three-dimensional image signal (the coded stream 100o) coded under the determined coding condition and corresponding to the three-dimensional image generated from the obtained two image signals 101iX and 101iY.

Accordingly, the code amount of a portion having the larger disparity and easily viewed (region 9A) increases, and the image quality can also increase. In addition, the code amount of a portion having the smaller disparity and having difficulty in being viewed (region 9B) can decrease. Thus, the higher image quality and the smaller code amount are compatible.

More specifically, the first portion having the larger disparity of the disparity information to be calculated may be another portion different from a portion to be focused on, when images are captured.

Furthermore, the first portion having the larger disparity does not need to have a (large) blur in an image though the portion is the other portion.

Furthermore, the second portion having the smaller disparity of the disparity information to be calculated may be a portion to be focused on, when the images are captured.

Furthermore, the second portion having the smaller disparity is a portion to be focused on, and does not need to have a (large) blur in an image as the first portion.

In other words, a depth of field when an image is captured may be a relatively large depth of field to the extent that the first and second portions have no blur.

For example, since an image capturing apparatus is a camera different from a single-lens reflex camera or a consumer movie camera, the depth of field may be large.

Furthermore, the first portion may be relatively easily viewed because it has no blur in the image, has the larger disparity, and is a portion at a short distance.

On the other hand, the second portion may have a relative difficulty in being viewed because it has the smaller disparity and is a portion at a long distance though it has a smaller disparity.

Accordingly, the first portion at the short distance can be prevented from being regarded as a portion with a smaller code amount even though the first portion is simply not a portion to be focused on and is the other portion despite being easily viewed. In other words, the first portion can be prevented from being regarded as a portion with a smaller code amount and having the reduced image quality, and the image quality can be reliably increased.

Furthermore, the second portion can be prevented from being regarded as a portion with a larger code amount even though the second portion is simply a portion to be focused despite having difficulty in being viewed. In other words, the second portion can be prevented from being regarded as a portion with a larger code amount, and the image quality can be reliably reduced.

In other words, the first portion may be coded under the first coding condition with a larger code amount in any cases including a case where the first portion is a portion to be focused on and another portion.

Furthermore, the second portion may be coded under the second coding condition with a smaller code amount in any cases including a case where the second portion is a portion to be focused on and another portion.

More specifically, the first portion to be easily viewed is a portion at a relatively short distance from the image-capturing positions PX and PY (FIG. 4). Here, the first portion has a large disparity in the calculated disparity information, and is to be coded under the first coding condition with the larger code amount.

Furthermore, the portion at the short distance may be, for example, a foreground portion, such as a building and a person, within a captured scene.

Furthermore, the second portion having difficulty in being viewed may be a background portion at a longer distance than the distance to the foreground portion. Here, the second portion has a small disparity, and is to be coded under the second coding condition with the smaller code amount.

The distance to the background portion may be, for example, an infinite distance for capturing an image.

More specifically, the disparity information to be calculated is, for example, information for identifying a disparity of the disparity information and information indicating the disparity.

Furthermore, the disparity information to be calculated may, for example, identify the disparity of a portion to be coded under the determined coding condition.

Furthermore, there are the first region in the first picture B2 (FIG. 7) indicated by the first image signal 101iX, and the second region in the second picture S3 indicated by the second image signal 101iY. The second picture S3 is at the same time as the first picture B2. In other words, the portion to be coded under the determined coding condition may include only one of the first and second regions.

Furthermore, the portion coded under the determined coding condition may be a portion including both at least a part of the first region and at least a part of the second region.

More specifically, the image coding unit 104 may code the second region in the second picture S3 indicated by the second image signal 101iY, with reference to the first region in the first picture B2 indicated by the image signal 101iX and located at the same time as the second picture S3.

The first region may be at a position with the motion indicated by a motion vector with respect to the position of the second region.

Furthermore, the motion vector estimating unit 102 may calculate the motion vector as the disparity information.

Accordingly, the calculated disparity information corresponds to a motion vector to be coded using some reference. Accordingly, the motion vector is used for the disparity information, and the processing can be simplified without adding any new processing.

More specifically, the disparity of the portion to be coded under the determined coding condition at a current time (time at the pictures B2 and S3 in FIG. 7) may be the same as the past (for example, time at the pictures I0 and S1) disparity of the portion or in a predetermined range from the past disparity.

Furthermore, the motion vector estimating unit 102 may calculate the disparity information of the past disparity (between the pictures I0 and S1).

The motion vector estimating unit 102 may calculate disparity information of the past disparity, for example, when the pictures I0 and S1 in the past are coded.

Furthermore, the quantization parameter determining unit 103 may determine a coding condition (quantization parameter 104p, etc.) for the current coding (coding of the pictures B2 and S3) based on the calculated past disparity information.

In other words, the first picture B2 is, for example, a base view picture. Furthermore, the second picture S3 is a dependent view picture.

The appropriate operation is performed on not only the second picture S3 that is a dependent view picture but also the first picture B2 that is a base view picture.

In other words, not only the second picture S3 that is a dependent view picture but also the first picture B2 that is a base view picture may be appropriately coded under an appropriate coding condition based on a disparity between the second picture S3 and the first picture B2, using disparity information of the past disparity. Accordingly, the picture can be appropriately coded with higher reliability.

Furthermore, for example, the quantization parameter in determining unit 103 may determine a coding condition for coding pictures (pictures B2 and S3) at the current time, based on the disparity information on a disparity between the pictures B2 and S3 at the current time (time of the pictures B2 and S3).

Accordingly, the reliable and appropriate operation can be performed because the operation according to the current disparity information with relatively high precision is performed.

Furthermore, since the disparity information calculated in the past is currently used, the complicated processing can be prevented and the processing can be simply performed.

FIG. 11 illustrates a pre-processing unit 99 and others.

As described above, the first picture B2 indicated by the first image signal 101iX and the second picture S3 indicated by the second image signal 101iY at the same time as the first picture B2 may be coded.

The stereo image coding apparatus 100 may include a coding unit 104c (FIG. 11) for at least performing the coding.

In other words, the coding unit 104c may include, for example, the image coding unit 104 in FIG. 1 or a part or an entire of the image coding unit 104.

Furthermore, the stereo image coding apparatus 100 may include the pre-processing unit 99 (FIG. 11) that processes the two pictures B2 and S3 prior to coding of one of the two pictures B2 and S3

Furthermore, the pre-processing unit 99 may include a matching processing unit 99P.

The matching processing unit 99P may calculate the disparity information on a disparity between the first picture B2 and the second picture S3. Furthermore, the matching processing unit 99P may calculate the disparity information prior to coding any one of the first picture B2 and the second picture S3.

Accordingly, any of the first picture B2 that is a base view picture and the second picture S3 that is a dependent view picture can be appropriately coded with higher reliability based on the disparity information.

Furthermore, the process performed by the pre-processing unit 99 for calculating the disparity information can be more simplified using the data generated in other processes except for the calculation of the disparity information.

For example, the quantization parameter determining unit 103 may obtain the disparity information 102g calculated by the matching processing unit 99P. Furthermore, the coding unit 104c may perform processing under the coding condition (quantization parameter 104p, etc.) determined by the quantization parameter determining unit 103 using the obtained disparity information 102g.

The quantization parameter determining unit 103 may be a part of the coding unit 104c, and may be provided outside of the coding unit 104c, for example, between the coding unit 104c and the pre-processing unit 99.

Furthermore, the pre-processing unit 99 may generate a reduced image 99a and a reduced image 99b (FIG. 11) respectively obtained by reducing the first picture B2 and the second picture S3, for example.

Furthermore, the matching processing unit 99P may calculate, using the two reduced images 99a and 99b, the disparity information 102g between the first picture B2 and the second picture S3 from which the reduced images 99a and 99b are calculated.

More specifically, the stereo image coding apparatus 100 may include an image capturing unit 101mX (FI/G. 11) that captures an is image of the first image signal 101iX to generate the first image signal 101iX.

After the image capturing unit 101mX changes its direction and its position, it may generate the first image signal 101iX of an image captured in the changed direction, etc.

Furthermore, the pre-processing unit 99 may identify an appropriate direction, etc. of the image capturing unit 101mX using the generated two reduced images 99a and 99b. In addition, the pre-processing unit 99 may perform control to change the direction of the image capturing unit 101mX into the identified appropriate direction.

In other words, the pre-processing unit 99 may control the image capturing unit 101mX upon output of a control signal for the control (FIG. 11).

The control is, for example, feedback control.

For example, the control may be based on information calculated using the generated two reduced images 99a and 99b.

In other words, the disparity information 102g (FIG. 11) calculated by the matching processing unit 99P may be, for example, information based on which the direction of the image capturing unit 101mX is controlled.

Accordingly, the processing in which the appropriate disparity information is calculated only using information for control can be simplified.

Each of the reduced images 99a and 99b may be, for example, an image having a size reduced to ¼.

The control may be performed based on the calculated information in the same manner on an image capturing unit 101mY (FIG. 11) that generates the second image signal 101iY.

Furthermore, out of the first region of the first picture B2 that is a base view picture of an image signal (for example, first image signal 101iX) and the second region of the second picture S3 that is a dependent view picture, only the second region may be coded under the determined coding condition (quantization parameter 104p in FIG. 1), for example.

In other words, the first region of the first picture B2 that is a base view picture does not need to be coded under the determined coding condition, for example.

Furthermore, the second region of the dependent view picture coded under the determined coding condition may have a code amount of coded data having a smaller difference with that obtained by coding the first region of the base view picture.

Accordingly, it is possible to avoid a case where a difference between the code amount of the first region and the code amount of the second region is so large that the code amount between a base view and a dependent view is off balance and the image quality is lowered. In other words, the difference in code amount is reduced, the code amount is well balanced, and the image quality can be increased.

More specifically, the first image signal 101iX of the base view may be coded under the first coding condition with which a relatively large code amount of coded data is obtained.

Furthermore, when the disparity of the calculated disparity information is a large disparity at a short distance (region 9A), the second image signal of the dependent view may be coded under the first coding condition that is the same condition used when the first image signal is coded and has a larger code amount.

Furthermore, when the disparity is a small disparity at a long distance (region 9B), the second image signal of the dependent view may be coded under the second coding condition having the code amount smaller than that of the first coding condition.

Accordingly, when a disparity is large, the dependent view picture is coded under the second coding condition having the smaller code amount, and the code amount (data amount) of a three-dimensional image signal to be generated can be reduced.

Furthermore, such a small data amount is a data amount that achieves a relatively smaller rate, for example, specified by the user as a rate of the three-dimensional image signal to be generated.

When a disparity is large, the dependent view picture is coded under the first coding condition with a large code amount, and the image quality can be sufficiently increased.

When a disparity is large, another image signal of the dependent view is coded under the first coding condition used when the first image signal of the base view is coded. Thus, a difference between the code amounts can be reduced, and the image quality can be increased to a large extent.

FIG. 12 illustrates a rate control unit 104w and others.

The rate control unit 104w is illustrated inside of the image coding unit 104 for convenience. Here, the rate control unit 104w may be outside or inside of the image coding unit 104.

For example, the rate control unit 104w may perform control to set the rate of the three-dimensional image signal to be generated (coded stream 100o) to a target rate.

At least a part of the processing for the control may be performed, for example, using a known rate control technique.

The coding under the first coding condition with a large code amount may be performed using a relatively high rate as the target rate, thus resulting in a large code amount of coded data.

Furthermore, the coding under the second coding condition with a small code amount may be performed using a relatively low rate as the target rate, thus resulting in a small code amount of coded data.

In other words, when the disparity of the calculated disparity information 102g (FIG. 12) is a disparity at a short distance, the rate control unit 104w may set the target rate to a higher rate, and increase the code amount.

Furthermore, when the disparity is a disparity at a long distance, a code amount control unit 98 may set the target rate to a lower rate, decrease the code amount.

In other words, the coding condition may be, for example, such a target rate.

Furthermore, the detailed operations may be performed according to a known technique, by adopting an improved invention, and by performing other operations. The case where any of these operations are performed belongs to the scope of the techniques of the present invention.

A part of the obtaining unit 101g (FIG. 1) that obtains two of the image signals 101iX and 101iY may be, for example, the input image memory in FIG. 1.

The standardization of the stereo image coding in such a technical field is currently being underway. Thus, the terms that are not relatively general at present will be relatively general in the future along with the standardization. When the terms that are not relatively general at present but will be relatively general in the future are obvious, these terms may be assumed to be replaced as necessary. For example, it is probable that the original terms will be amended to obvious terms in the future.

The summary of the above description is as follows. The obtaining unit 101g in FIG. 1 is disclosed as an example of the “obtaining unit”. Furthermore, the motion vector estimating unit 102 is disclosed as an example of the “calculating unit”. Furthermore, the quantization parameter determining unit 103 is disclosed as an example of the “determining unit”. Furthermore, the image coding unit 104 is disclosed as an example of the “generating unit”.

The present invention is described based on the embodiment, but the present invention is not limited to this. Those skilled in the art will readily appreciate that many modifications are possible in exemplary embodiments without materially departing from the novel teachings and advantages of the present invention. The embodiment described in the Description is only an example, and other embodiments different from the embodiment may be implemented. The present invention can be implemented as an integrated circuit, a method using the processing units included in the apparatus as steps, a program causing a computer to execute such steps, a recording medium, such as a computer-readable CD-ROM on which the program is recorded, and information, data, or a signal indicating the program. The program, information, data, and signal may be distributed via a communication network, such as the Internet.

### INDUSTRIAL APPLICABILITY

The stereo image coding apparatus and the stereo image coding method according to the present invention can code an image in accordance with a compression coding scheme, such as the H.264, with high image quality and high efficiency. Thus, the present invention is applicable to personal computers, HDD recorders, DVD recorders, and cellular phones equipped with cameras.

### REFERENCE SIGNS LIST

100 Stereo image coding apparatus
100o Coded stream
101 Input image memory
101iX Image signal
1011Y Image signal
102 Motion vector estimating unit
102g Disparity information
103 Quantization parameter determining unit
104 Image coding unit
104p Quantization parameter
105 Reference image memory
201 Intra prediction unit
202 Motion compensation unit
203 Prediction mode determining unit
204 Difference calculating unit
205 Orthogonal transformation unit
206 Quantization unit
207 Inverse quantization unit
208 Inverse orthogonal transformation unit
209 Adding unit
210 Entropy coding unit

1. A stereo image coding apparatus comprising:
an obtaining unit configured to obtain two image signals captured at two different positions, the two image signals being a first image signal and a second image signal;
a calculating unit configured to calculate disparity information on a disparity between the two image signals obtained by said obtaining unit;
a determining unit configured to determine a coding condition based on the disparity information calculated by said calculating unit so that a portion of a three-dimensional image generated from the obtained two image signals has a larger code amount as a current disparity or a past disparity of the portion is larger; and
a generating unit configured to code the three-dimensional image generated from the obtained two image signals, under the coding condition determined by said determining unit to generate a three-dimensional image signal indicating the three-dimensional image.

2. The stereo image coding apparatus according to claim 1,
wherein said calculating unit is configured to calculate the disparity information of the disparity in the portion to be coded under the determined coding condition,
the coding condition is a quantization parameter for quantization when the portion is coded, and
said determining unit is configured to determine: (i) a first quantization parameter when the calculated disparity information is disparity information for identifying a disparity at a first distance; and (ii) a second quantization parameter such that a code amount obtained when the quantization is performed with the second quantization parameter is smaller than a code amount obtained when the quantization is performed with the first quantization parameter, when the calculated disparity information is disparity information for identifying a disparity at a second distance longer than the first distance.

3. The stereo image coding apparatus according to claim 2,
wherein said determining unit is configured to determine the first quantization parameter when an amount of disparity characteristics is equal to or larger than a predetermined first threshold, the amount of disparity characteristics being calculated using a horizontal component of the disparity information and being indicated by a larger value as the portion from which the amount of disparity characteristics is obtained is closer to a person.

4. The stereo image coding apparatus according to claim 2,
wherein said determining unit is configured to determine the second quantization parameter when an amount of disparity characteristics is equal to or smaller than a predetermined second threshold, the amount of disparity characteristics being obtained from a horizontal component of the disparity information, and being indicated by a larger value as the portion from which the amount of disparity characteristics is obtained is closer to a person.

5. The stereo image coding apparatus that is a video camera according to claim 1, further comprising
an optical system that divides light obtained through one lens into (i) light from which the first image signal is generated and (ii) other light from which the second image signal is generated,
wherein said generating unit is configured to code the first image signal generated from the light and the second image signal generated from the other light to generate the three-dimensional image signal.

6. The stereo image coding apparatus according to claim 1,
wherein said generating unit is configured to code a second region in a second frame of the second image signal, with reference to a first region in a first frame of the first image signal, the first frame being at a same time as the second frame,
a position of the first region is a position with a motion indicated by a motion vector with respect to a position of the second region, and
said calculating unit is configured to calculate the motion vector as the disparity information.

7. The stereo image coding apparatus according to claim 6,
wherein the disparity of the portion to be coded under the determined coding condition at a current time is the same as the past disparity of the portion or in a predetermined range from the past disparity,
said determining unit is configured to calculate disparity information of the past disparity, and
said generating unit is configured to determine the coding condition of the coding at the current time, based on the calculated disparity information of the past disparity.

8. The stereo image coding apparatus according to claim 6,
wherein said determining unit is configured to determine the coding condition of the coding at a current time, based on the calculated disparity information of the disparity at the current time.

9. The stereo image coding apparatus according to claim 1,
wherein said generating unit is configured to code a first frame of the first image signal and a second frame of the second image signal at a same time as the first frame, and
said calculating unit is included in a pre-processing unit configured to process the first and second frames prior to coding any one of the two frames, and is configured to calculate the disparity information of the disparity between the two frames prior to coding any one of the two frames.

10. The stereo image coding apparatus according to claim 9,
wherein said pre-processing unit is configured to generate respective reduced images of the first frame and the second frame, and
said calculating unit is configured to calculate the disparity information from the generated two reduced images.

11. The stereo image coding apparatus according to claim 1,
wherein said generating unit is configured to code, out of a region of the first image signal and a region of the second image signal, only the region of the second image signal under the determined coding condition, and
the region of the second image signal coded under the determined coding condition has a code amount having a difference with a code amount obtained when the region of the first image signal is coded, the difference being smaller than a third threshold.

12. The stereo image coding apparatus according to claim 1,
wherein the disparity information is information indicating at least one of a distance and a direction between a first region in a first frame of the first image signal and a second region in a second frame of the second image signal, the second frame being at a same time as the first frame, and the first region and the second region having respective captured images of a same object.

13. A stereo image coding method comprising:
obtaining two image signals captured at two different positions, the two image signals being a first image signal and a second image signal;
calculating disparity information on a disparity between the two image signals obtained in said obtaining;
determining a coding condition based on the disparity information calculated in said calculating so that a portion of a three-dimensional image generated from the obtained two image signals has a larger code amount as a current disparity or a past disparity of the portion is larger; and
coding the three-dimensional image generated from the obtained two image signals, under the coding condition determined in said determining to generate a three-dimensional image signal indicating the three-dimensional image.

14. The stereo image coding method according to claim 13,
wherein in said generating, a first frame of the first image signal is coded prior to coding of a second frame of the second image signal, the first frame being at a same time as the second frame,
in said calculating, the disparity information of the disparity between the first and second frames is calculated prior to coding of the first frame in said generating,
in said determining, the coding condition is determined based on the disparity information between the first and second frames calculated in said calculating, prior to coding of the first frame, and
in said generating, a first region included in the first frame is coded under the determined coding condition.

15. The stereo image coding method according to claim 14, further comprising
storing the first and second frames in an input buffer prior to coding of the first frame in said generating, and
in said calculating, the disparity information is calculated using the first and second frames stored in the input buffer, prior to coding of the first frame.
